(19) United States
(12) Patent Application Publication
(10) Pub. No.: US 2025/0115154 A1
(43) Pub. Date: Apr. 10, 2025

(54) VEHICLE AND MANAGEMENT METHOD FOR POWER STORAGE DEVICE

(71) Applicant: TOYOTA JIDOSHA KABUSHIKI KAISHA, Toyota-shi (JP)

(72) Inventors: Kazuki IWAMA, Nisshin-shi (JP); Yuki IMADE, Okazaki-shi (JP)

(73) Assignee: TOYOTA JIDOSHA KABUSHIKI KAISHA, Toyota-shi (JP)

(21) Appl. No.: 18/891,515

(22) Filed: Sep. 20, 2024

(30) Foreign Application Priority Data
Oct. 6, 2023 (JP) 2023-174332

(51) Int. Cl. B60L 53/66; B60L 53/62; B60L 58/12

(52) U.S. Cl. CPC B60L 53/665; B60L 53/62; B60L 58/12; B60L 2260/44; B60L 2260/54

(57) ABSTRACT

A management method for a power storage device includes: counting, for each day of week, the number of days satisfying at least a first requirement indicating that charging of the power storage device was performed, and a second requirement indicating that a time when use of the power storage device was started is included in a predetermined time period; identifying a day of week on which usage of the power storage device by a user is patterned, by using the number of days counted for each day of week; determining a recommended charging condition for the power storage device for the identified day of week; and notifying the user of the recommended charging condition for the identified day of week.

### CROSS REFERENCE TO RELATED APPLICATIONS

This nonprovisional application is based on Japanese Patent Application No. 2023-174332 filed on Oct. 6, 2023 with the Japan Patent Office, the entire contents of which are hereby incorporated by reference.

### BACKGROUND

### Field

The present disclosure relates to a vehicle including a power storage device, and a management method for the power storage device.

### Description of the Background Art

Japanese Patent Laying-Open No. 2022-139225 discloses a technique for prompting a user to charge a battery when the remaining amount of the battery of the electric motor mobile object falls below a recommended charging threshold. In this technique, a median value of consumption amounts for n past days is set as an estimated consumption amount for one day. Then, a value obtained by adding the estimated consumption amount and the margin amount to a predetermined lower limit amount is set as the recommended charging threshold.

### SUMMARY

In the technique described in Japanese Patent Laying-Open No. 2022-139225, it is recommended to charge the power storage device at a timing when the power storage amount in the power storage device reaches a predetermined value (a recommended charging threshold). However, some users daily use the power storage device desire to charge the power storage device according to their convenience. The timing at which the power storage amount of the power storage device reaches the predetermined value is not limited to the charging start timing convenient for the user. In the above technique, deterioration of the power storage device is suppressed by increasing the charging amount per charging to reduce the frequency of charge. However, for a user who daily charges a power storage device using a home power supply facility, it tends to be more convenient to perform a small amount of charging at a high frequency. According to the technique described in Japanese Patent Laying-Open No. 2022-139225, it is difficult to present, to a user, a charging condition that achieves both suppression of deterioration of a power storage device and convenience of the user.

The present disclosure has been made to solve the above-described problem, and an object of the present disclosure is to present, to a user, a charging condition that achieves both suppression of deterioration of a power storage device and convenience of the user.

According to one aspect of the present disclosure, a vehicle including a power storage device and a controller is provided. The controller is configured to count, for each day of week, the number of days satisfying at least a first requirement indicating that charging of the power storage device was performed, and a second requirement indicating that a time when use of the power storage device was started is included in a predetermined time period, identify a day of week on which usage of the power storage device by a user is patterned, by using the number of days counted for each day of week, determine a recommended charging condition for the power storage device for the identified day of week, and notify the user of the recommended charging condition for the identified day of week.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating a configuration of a vehicle according to an embodiment of the present disclosure.

FIG. 2 is a flowchart showing charging control of the power storage device by the vehicle shown in FIG. 1.

FIG. 3 is a flowchart showing processing relating to management of charging conditions referred to in charging control of the power storage device shown in FIG. 2.

FIG. 4 is a diagram for describing processing related to updating of a recommended condition and specifying of a target day of the week in the management method for the power storage device according to the embodiment of the present disclosure.

FIG. 5 is a flowchart illustrating processing for determining a first recommended condition for a target day of the week in the management method for the power storage device according to the embodiment of the present disclosure.

FIG. 6 is a flowchart illustrating processing for determining a second recommended condition for a target day of the week in the management method for the power storage device according to the embodiment of the present disclosure.

### DESCRIPTION OF THE PREFERRED EMBODIMENTS

Embodiments of the present disclosure will be described in detail below with reference to the drawings. The same or corresponding elements in the drawings have the same reference characters allotted and description thereof will not be repeated.

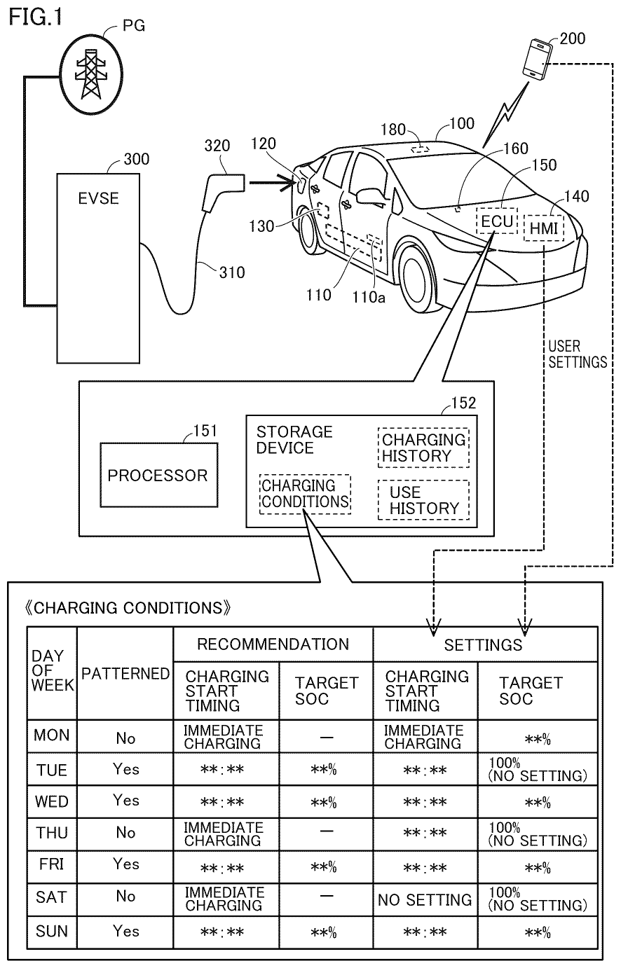

FIG. 1 is a diagram for explaining a configuration of a vehicle according to this embodiment. Referring to FIG. 1, vehicle 100 includes power storage device 110, BMS (Battery Management System) 110a, inlet 120, charging circuit 130, HMI (Human Machine Interface) 140, ECU (Electronic Control Unit) 150, activation switch 160, and communication device 180. The vehicle 100 is, for example, an electrically powered vehicle (hereinafter also referred to as “xEV”) that can travel using electric power stored in the power storage device 110. Examples of the xEV include a battery electric vehicle (BEV), a plug-in hybrid electric vehicle (PHEV) and a fuel cell electric vehicle (FCEV).

The power storage device 110 includes a secondary battery (e.g., a lithium-ion secondary battery or a nickel metal hydride secondary battery). A plurality of secondary batteries may form a battery assembly. The power storage device 110 may include an electric double layer capacitor instead of the secondary battery. BMS 110a detects the state (e.g., temperature, current, voltage, and SOC) of power storage device 110, and outputs the detection result to ECU 150. The SOC (State Of Charge) indicates the ratio of the current power storage amount to the power storage amount in the fully charged state. In this embodiment, the power storage amount in power storage device 110 is represented by SOC.

The vehicle 100 is configured to perform external charging (charging with power from outside the vehicle). Specifically, vehicle 100 is configured to be able to charge power storage device 110 using power supplied from EVSE (Electric Vehicle Supply Equipment) 300. The EVSE 300 is a power supply facility (AC power supply facility) that outputs AC power. The EVSE 300 is installed in the home or workplace of a user (vehicle user) of the vehicle 100 and is routinely used by the vehicle user. The EVSE 300 includes a main body portion electrically connected to the power grid PG and a charging cable 310 extending outward from the main body portion. The power grid PG is an electric power network constructed by power transmission and distribution facilities, and supplies AC power. The inlet 120 of the vehicle 100 is configured such that a connector 320 (distal end portion) of the charging cable 310 is detachable. In a state where the connector 320 of the charging cable 310 is connected to the inlet 120 of the vehicle 100 in the parked state (plug-in state), the vehicle 100 is supplied with power from the EVSE 300. On the other hand, in the unconnected state of the inlet 120 (plug-out state), the vehicle 100 is not supplied with power from the EVSE 300. The vehicle 100 further includes a connection detection circuit (not shown) that detects the state (plug-in state/plug-out state) of the inlet 120.

When the vehicle 100 enters the plug-in state, preparation for external charging by the vehicle 100 is completed. The plug-in state corresponds to an example of the “chargeable state” according to the present disclosure. In external charging, power supplied from the power grid PG is input to the inlet 120 via the EVSE 300. The charging circuit 130 generates charging power in accordance with an instruction from the ECU 150 using the power supplied from the inlet 120, and inputs the generated charging power to the power storage device 110. The charging circuit 130 is controlled by the ECU 150.

HMI 140 includes an input device that outputs information input by the user to ECU 150, and an output device (notification device) that outputs information to the user in accordance with an instruction from ECU 150. Examples of input devices include buttons, keypads, and smart speakers that accept voice input. Examples of the output device include a display device and a speaker. The HMI 140 may include a touch panel display.

The activation switch 160 is a switch for starting the vehicle system. The state (on/off) of the activation switch 160 is switched according to a user operation. When the user turns the activation switch 160 from the on state to the off state, the vehicle system stops. When the user turns the activation switch 160 from the off state to the on state, the vehicle system is activated. In general, the activation switch is referred to as a “power switch”, an “ignition switch”, or the like. Hereinafter, the time at which the activation switch 160 is switched from the OFF state to the ON state (the time at which the process for activating the control system of the vehicle 100 is started) is referred to as an “IGON time”. The time at which the activation switch 160 is switched from the ON state to the OFF state (the time at which the process for stopping the control system of the vehicle 100 is started) is referred to as an “IGOFF time”.

The communication device 180 includes a communication I/F (interface) for wireless communication. The ECU 150 is configured to communicate with a mobile terminal 200 through the communication device 180. The mobile terminal 200 is carried and operated by a vehicle user. In this embodiment, a smartphone having a touch panel display is employed as the mobile terminal 200. The smartphone incorporates a computer and has a speaker function. Application software for charge management (such as notification described later) is installed in the mobile terminal 200. Note that the mobile terminal 200 is not limited to a smartphone, and may be a laptop, a tablet terminal, a portable game machine, a wearable device, or an electronic key.

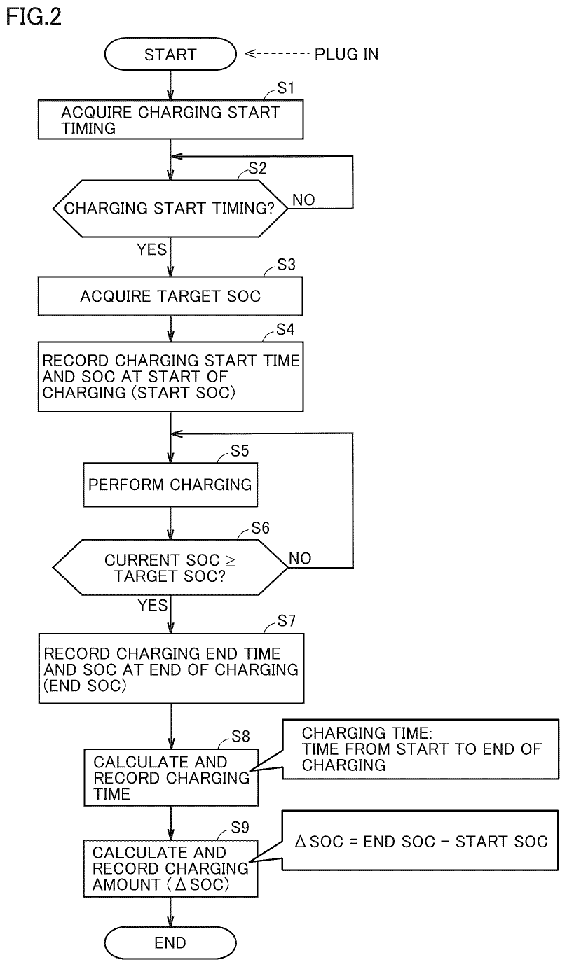

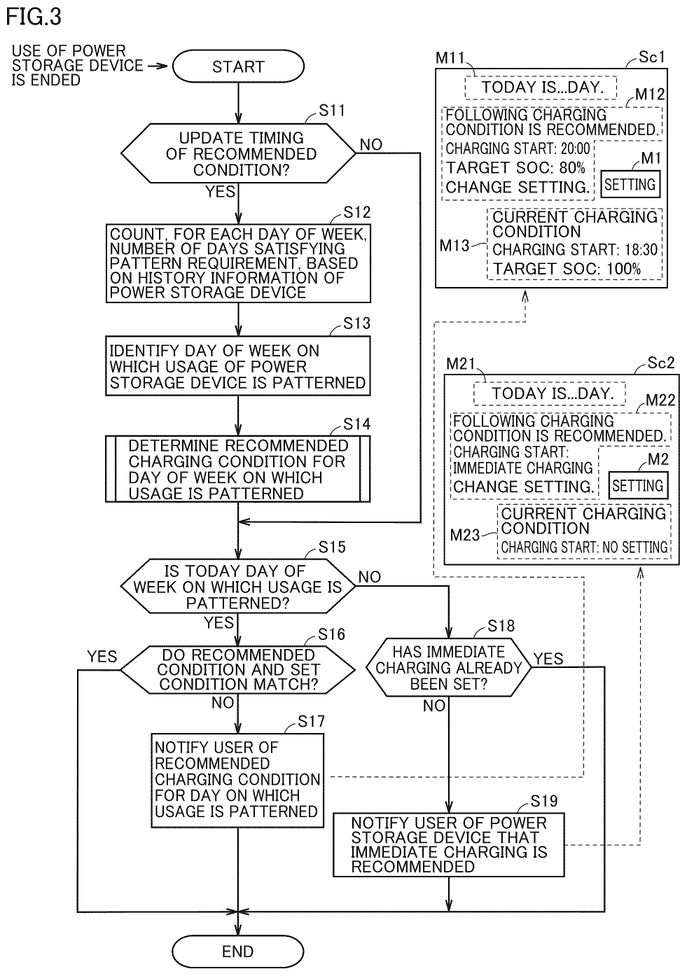

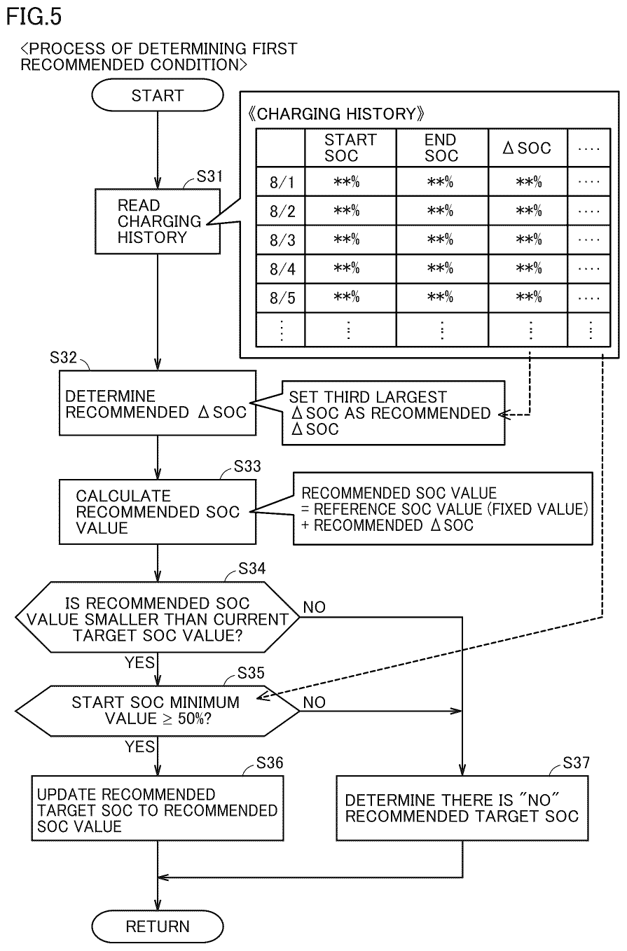

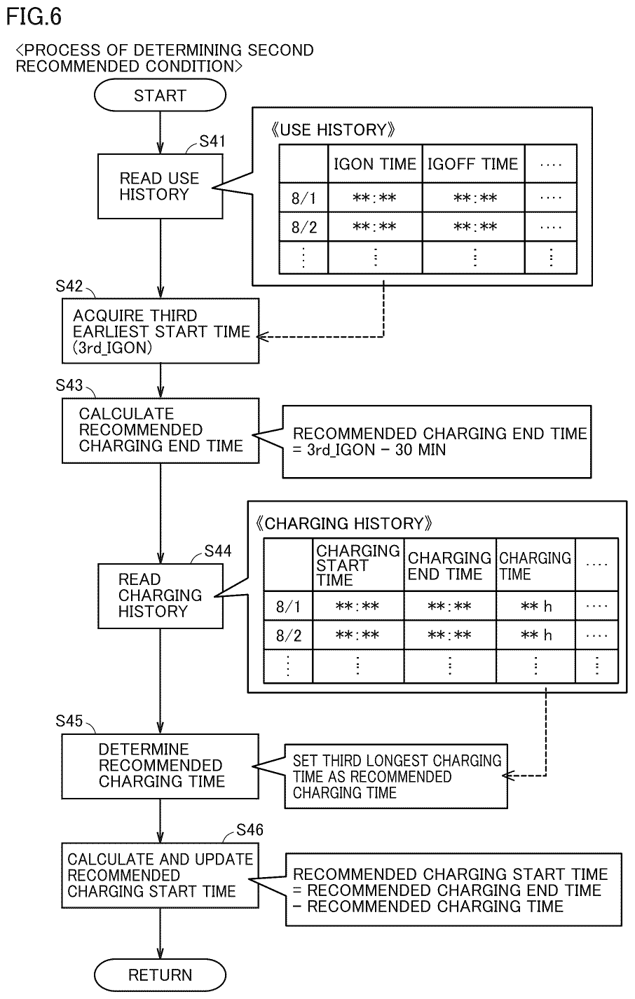

The ECU 150 includes a processor 151 and a storage device 152. The storage device 152 stores a program to be executed by the processor 151. When the processor 151 executes the program in the storage device 152, various calculations and various controls illustrated in FIG. 2, FIG. 3, FIG. 5, and FIG. 6 described later are executed. However, various processes by the ECU 150 may be executed only by hardware (electronic circuit) without using software. The ECU 150 corresponds to an example of a “controller” according to the present disclosure.

ECU 150 is configured to record first information (hereinafter also referred to as “charging history information”) relating to the charging history of power storage device 110 and second information (hereinafter also referred to as “use history information”) relating to the use history of power storage device 110 in storage device 152. The charging history information indicates a charging start time of power storage device 110, a charging end time of power storage device 110, an SOC of power storage device 110 at the start of charge (hereinafter referred to as a “start SOC”), an SOC of power storage device 110 at the end of charge (hereinafter referred to as an “end SOC”), a time from the start of charge of power storage device 110 to the end of charge (hereinafter referred to as a “charging time”), and an amount of electric power charged in power storage device 110 (hereinafter referred to as a “charging amount”). Every time the power storage device 110 is charged by the EVSE 300, the charging start time, the charging end time, the start SOC, the end SOC, the charging time, and the charging amount related to the charging are added to the storage device 152. The use history information indicates an IGON time (use start time of the power storage device 110) and an IGOFF time (use end time of the power storage device 110). Every time the state (on/off) of the activation switch 160 is switched, a new IGON time or IGOFF time is added to the storage device 152.

The ECU 150 specifies a day of the week on which the usage of the power storage device 110 by the vehicle user is patterned, and determines a recommended charging condition for the specified day of the week. For each day of the week, ECU 150 records information indicating whether or not the usage of power storage device 110 by the vehicle user is patterned (hereinafter referred to as “usage information”) in storage device 152. In addition, ECU 150 recommends immediate charging (that is, charging to be started as soon as the vehicle 100 becomes a chargeable state) for a day of the week on which the usage of power storage device 110 by the vehicle user is not patterned. Recommended charging conditions (hereinafter also referred to as “recommended conditions”) of the power storage device 110 for each day of the week are stored in the storage device 152.

The vehicle user can set the charging condition in the ECU 150 through the HMI 140 or the mobile terminal 200. Specifically, the ECU 150 is configured to set the charging start timing and the target SOC (SOC value indicating the end-of-charging power storage amount) for each day of the week based on an input from the user. The charging condition is set for each day of the week. The charging conditions set in the ECU 150 (hereinafter also referred to as “set conditions”) are stored in the storage device 152. The ECU 150 performs charging control of the power storage device 110 based on the set condition. Specifically, ECU 150 starts charging power storage device 110 in accordance with the set charging start timing. When the SOC of power storage device 110 reaches the set target SOC, ECU 150 ends charging of power storage device 110. For a day of the week on which the target SOC is not set, an initial value (e.g., 100% indicating full charge) predetermined as the target SOC is set in the ECU 150. The ECU 150 is configured to accept the charging start timing that includes a first charging start timing indicating a charging start time specified by the user and a second charging start timing indicating a timing when vehicle 100 becomes a chargeable state. The vehicle user can designate an arbitrary time as the first charging start timing and set it in the ECU 150. For the day of the week when the charging start timing is not set, “no setting” is stored in the storage device 152 as the charging start timing. When the charging start timing is not set for all the days of the week, an initial timing (for example, the second charging start timing for immediate charging) predetermined as the charging start timing is set in the ECU 150 for all the days of the week.

FIG. 2 is a flowchart showing charging control of the power storage device 110 executed by the ECU 150. In this embodiment, when the vehicle 100 in the parked state is connected to the EVSE 300 (the plug-in state described above), the charging control illustrated in FIG. 2 is started. When the vehicle 100 enters the plug-out state while the charging control illustrated in FIG. 2 is executed, the charging control is stopped. Each step in the flowchart is simply referred to as “S”.

Referring to FIG. 2, in S1, processor 151 reads the set charging start timing from storage device 152. Subsequently, in S2, the ECU 150 determines whether or not the set charging start timing has arrived. When the charging start timing set in ECU 150 is the first charging start timing, ECU 150 waits until the charging start time designated by the user arrives (NO in S2), and when the designated charging start time arrives (YES in S2), the process proceeds to S3. When the charging start timing set in the ECU 150 is the second charging start timing, the process proceeds to S3 without waiting in S2. When the charging start timing is not set for the day of the week today, the ECU 150 waits in S2 until the next charging start timing that is set (on the next day or later) arrives.

In S3, the processor 151 reads the set target SOC from the storage device 152. In S4, the ECU 150 records the current time in the storage device 152 as charging history information (charging start time). ECU 150 also records the current SOC of power storage device 110 in storage device 152 as charging history information (start SOC). Subsequently, in S5, the ECU 150 starts external charging of the power storage device 110. When the second charging start timing is set in the ECU 150, the immediate charging is executed. In S5, the ECU 150 controls the charging circuit 130 so that the power storage device 110 is charged by the electric power supplied from the EVSE 300. This charging raises the SOC of the power storage device 110. In subsequent S6, the ECU 150 determines whether or not the SOC of the power storage device 110 is equal to or higher than the set target SOC. While the SOC of power storage device 110 is less than the target SOC (NO in S6), S5 and S6 are repeated. Thus, the external charging (S5) of the power storage device 110 is continuously performed. When the SOC of power storage device 110 reaches the target SOC (YES in S6), the process proceeds to S7. As a result, the external charging ends.

In S7, the ECU 150 records the current time as the charging history information (charging end time) in the storage device 152. ECU 150 also records the current SOC of power storage device 110 in storage device 152 as charging history information (end SOC). Subsequently, in S8, the ECU 150 calculates the charging time using the charging start time (S4) and the charging end time (S7), and records the calculated charging time in the storage device 152 as the charging history information. Subsequently, in S9, the ECU 150 calculates ΔSOC (=end SOC-start SOC) by subtracting the start SOC (S4) from the end SOC (S7), and records the calculated ΔSOC in the storage device 152 as charging history information. ΔSOC indicates the charging amount.

FIG. 3 is a flowchart illustrating a process related to the update and notification of the recommended condition performed by the ECU 150. In this embodiment, the processing flow shown in FIG. 3 is started every time the activation switch 160 is switched from the ON state to the OFF state.

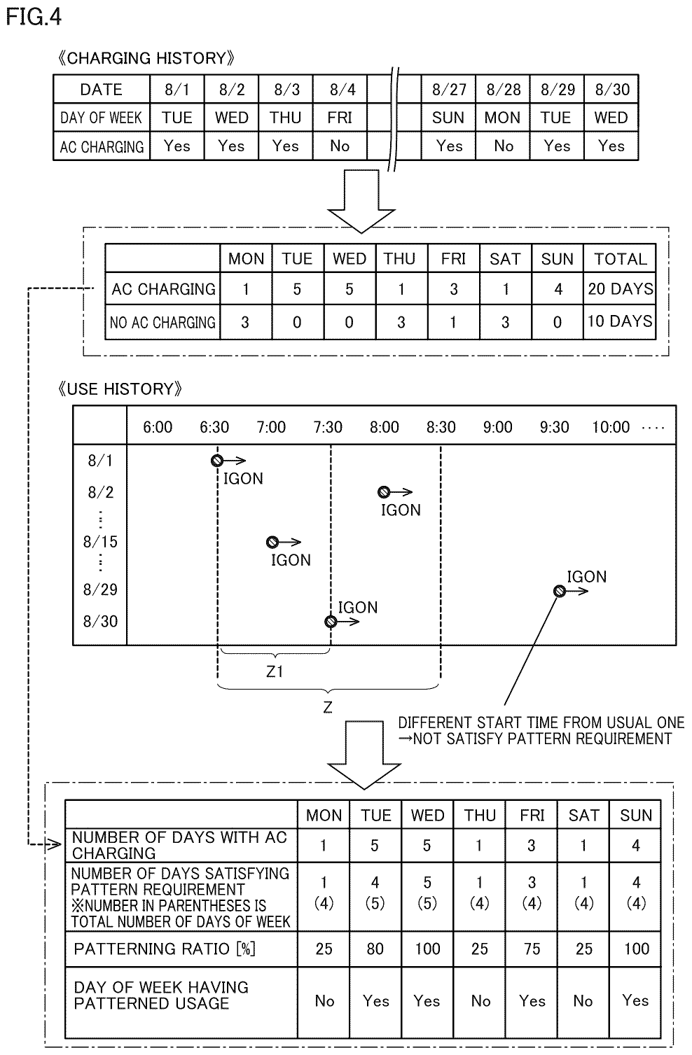

Referring to FIG. 3, in S11, ECU 150 determines whether or not the update timing of the recommended condition has come. When it is determined that the update timing of the recommended condition has arrived (YES in S11), the ECU 150 determines whether or not a predetermined requirement (hereinafter, referred to as “pattern requirement”) is satisfied for each day of the target period in subsequent S12, and counts the number of days satisfying the pattern requirement for each day of the week. Further, in S13, ECU 150 identifies the day of the week on which the usage of power storage device 110 by the user is patterned, using the number of days counted for each day of the week in S12. Then, the ECU 150 updates the usage information stored in the storage device 152 based on the determination result of S13. FIG. 4 is a diagram for explaining the processing of S11 to S13 in FIG. 3.

Referring to FIG. 4, in S11 of FIG. 3, when a predetermined update requirement is satisfied, it is determined that the update timing of the recommended condition has come. In this embodiment, in the target period, when the number of days when the external charging of the power storage device 110 is executed by the EVSE 300 shown in FIG. 1 is equal to or more than a predetermined number of days (for example, 20 days), the update requirement is satisfied. The target period is reset every time YES is determined in S11. The target period is a period from the next day of the reset day to the day determined to be YES in S11. In the example shown in FIG. 4, the target period is a period from Aug. 1 to Aug. 30, 2023.

In S11, the ECU 150 determines whether or not the update requirement is satisfied based on the charging history information stored in the storage device 152. Execution of external charging of power storage device 110 by EVSE 300 means that both the requirement (hereinafter referred to as “first requirement”) that power storage device 110 has been charged and the requirement (hereinafter referred to as “EVSE requirement”) that power storage device 110 has been charged by EVSE 300 (predetermined power supply facility) are satisfied. In the charging history shown in FIG. 4, a day on which “AC charging” is Yes is a day (an AC charging day) on which both the first requirement and the EVSE requirement are satisfied, and a day on which “AC charging” is No is a day (a not-AC charging day) on which at least one of the first requirement and the EVSE requirement is not satisfied. In the example shown in FIG. 4, the number of AC charging days reaches 20 days on August 30, and the update requirement is satisfied.

In addition to the first requirement and the EVSE requirement, the pattern requirement further includes a second requirement indicating that the time at which the use of the power storage device 110 was started is included in a predetermined time period (hereinafter, referred to as “time period Z”). The ECU 150 sets the time period Z based on the use history information stored in the storage device 152. Specifically, the ECU 150 confirms the time at which the activation switch 160 is first turned on in one day (hereinafter, referred to as “vehicle activation time”) for each day of the target period. When one day includes a plurality of IGON times, the first IGON time in the day corresponds to the vehicle start time. Subsequently, the ECU 150 identifies a time period (hereinafter, referred to as “time period Z1 ”) from the earliest vehicle activation time to the nth earliest vehicle activation time (n is an integer of 2 or more) based on the vehicle activation time of each day of the target period. In this embodiment, n is 3. In the example shown in FIG. 4, the time period Z1 is 6:30 to 7:30. Subsequently, the ECU 150 sets, as the time period Z, a time period (e.g., 6:30 to 8:30) in which a predetermined margin (e.g., one hour) is added after the specified time period Z1. In the usage of patterned vehicle 100 (power storage device 110), it is estimated that the IGON time is included in time period Z.

In S12 of FIG. 3, the ECU 150 counts the number of days satisfying the pattern requirement (the number of days satisfying all of the first requirement, the second requirement, and the EVSE requirement) in the target period for each day of the week. For example, the ECU 150 counts the number of AC charging days in the target period for each day of the week based on the charging history information. In the example shown in FIG. 4, the numbers of days on which AC charging is performed on Monday, Tuesday, Wednesday, Thursday, Friday, Saturday, and Sunday are “1 day”, “5 days”, “5 days”, “1 day”, “3 days”, “1 day”, and “4 days”, respectively. Subsequently, the ECU 150 excludes the number of days not satisfying the second requirement from the number of AC charging days counted for each day of the week. As a result, the number of days (hereinafter referred to as “target days”) satisfying the pattern requirement is obtained for each day of the week of the target period. In the example shown in FIG. 4, one day of “5 days” on Tuesday does not satisfy the second requirement. Therefore, the number of target days of Monday, Tuesday, Wednesday,

Thursday, Friday, Saturday, and Sunday is “1 day”, “4 days”, “5 days”, “1 day”, “3 days”, “1 day”, and “4 days”, respectively. Subsequently, the ECU 150 calculates the patterning ratio for each day of the week by dividing the number of target days counted for each day of the week in the target period by the total number of days of the week in the target period (total number of AC charging days and not-AC charging days for each day of the week). In the example shown in FIG. 4, the patterning ratios of Monday, Tuesday, Wednesday, Thursday, Friday, Saturday, and Sunday are calculated as “25% (=¼)”, “80% (=⅘)”, “100% (= 5/5)”, “25% (=¼)”, “75% (=¾)”, “25% (=¼)”, and “100% (= 4/4)”, respectively. In S13 of FIG. 3, ECU 150 identifies a day of the week on which the patterning ratio is equal to or higher than a predetermined value (e.g., 30%) among Monday, Tuesday, Wednesday, Thursday, Friday, Saturday, and Sunday as a day of the week on which the usage of power storage device 110 by the vehicle user is patterned (hereinafter referred to as “target day of the week”). In the example shown in FIG. 4, Tuesday, Wednesday, Friday, and Sunday are identified as target days of the week. The patterning ratio for each day of the week tends to show a higher value as the usage of the power storage device 110 for that day of the week is more likely to be patterned. By using such a patterning ratio in the process of S13, ECU 150 can accurately identify the day of the week (target day of the week) on which the usage of power storage device 110 by the user is patterned.

In the processing flow shown in FIG. 3, the number of days counted for each day of the week in S12 is used to identify the day of the week on which the usage of the power storage device 110 by the user is patterned (S13). In many cases, the behavior of the user is patterned for each day of the week. For example, a user may go home at a predetermined time to work from Monday to Friday but not on Saturdays and Sundays. Thus, the user often takes a predetermined action for each day of the week. In addition, the user who continuously uses the power storage device 110 repeatedly uses (discharges) the power storage device 110 and charges the power storage device 110. The power storage amount in the power storage device 110 decreases due to the use of the power storage device 110, and the power storage amount in the power storage device 110 increases (recovers) due to the charging of the power storage device 110. The inventor of the present application has found that by using the number of days satisfying both the first requirement related to the charging of the power storage device 110 and the second requirement related to the use of the power storage device 110, it is possible to specify a day of the week on which the usage of the power storage device 110 by the user is likely to be patterned. According to the above processing flow, it is easy to accurately specify the day of the week (target day of the week) on which the usage of the power storage device 110 is patterned.

Referring again to FIG. 3, in subsequent S14, ECU 150 determines a recommended condition (a recommended charging condition of power storage device 110) for the target day of the week. In this embodiment, the ECU 150 determines the recommended condition by a series of processes shown in FIGS. 5 and 6 described below.

FIG. 5 is a flowchart showing a process for determining a first recommended condition (recommended target SOC) for a target day of the week. Referring to FIG. 5, the processor 151 reads the charging history information of the target period from the storage device 152 in S31, and sets the m-th largest ΔSOC (m: an integer equal to or larger than 1) in the charging history information of the target period as the recommended ΔSOC in S32. In this embodiment, m is 3. The ΔSOC (charging amount) for each charging is recorded by the processing flow (S9) shown in FIG. 2.

Subsequently, in S33, the ECU 150 calculates a recommended SOC value by adding a predetermined reference SOC value to the recommended ΔSOC. In this embodiment, the reference SOC value is set to 60% (fixed value). As the reference SOC value, a power storage amount for avoiding electric deficiency is set. Subsequently, in S34 and S35, the ECU 150 determines whether or not the predetermined condition is satisfied.

In S34, the ECU 150 determines whether or not the obtained recommended SOC value is lower than the target SOC set in the ECU 150 at the present time. In S35, the ECU 150 determines whether or not the p-th lowest start SOC (p: an integer equal to or larger than 1) in the charging history information of the target period is equal to or larger than a predetermined threshold. In this embodiment, p is 1 and the threshold is 50%. That is, in S35, it is determined whether or not the lowest start SOC (the start SOC minimum value) in the target period is 50% or more.

If it is determined YES in both S34 and S35, the process proceeds to S36. In S36, the ECU 150 sets the recommended SOC value calculated in S33 as the recommended target SOC for the target day of the week stored in the storage device 152 (update of the recommended condition).

On the other hand, when it is determined NO in any one of S34 and S35, the process proceeds to S37. In S37, the ECU 150 determines that there is no recommended target SOC, and sets the recommended target SOC for the target day of the week stored in the storage device 152 to “no” (update of the recommended condition). Determining NO in S34 means that a sufficiently low target SOC is set in the ECU 150. The determination of NO in S35 means that the user is charging the power storage device 110 after the power storage amount in the power storage device 110 becomes sufficiently small. In such a charging method, the power storage device 110 is less likely to deteriorate. It is considered that it is not necessary to prompt the user to change the charging method.

FIG. 6 is a flowchart showing a process for determining a second recommended condition (a recommended charging start time) for a target day of the week. Referring to FIG. 6, in S41, processor 151 reads the use history information of the target period from storage device 152, and in S42, acquires the q-th earliest vehicle activation time (q: an integer equal to or greater than 1) in the use history information of the target period. In this embodiment, q is 3. Hereinafter, the q-th earliest vehicle activation time acquired in S42 is referred to as “3rd_IGON time”. Next, in S43, the ECU 150 sets a time that is earlier than the 3rd_IGON time by a predetermined time (for example, 30 minutes) as the recommended charging end time (recommended charging end time).

Subsequently, in S44, the processor 151 reads the charging history information of the target period from the storage device 152, and in S45, acquires the r-th longest charging time (r: an integer of 1 or more) in the charging history information of the target period. In this embodiment, r is 3. The charging time for each charging is recorded by the processing flow (S8) shown in FIG. 2. The ECU 150 sets the r-th longest charging time obtained in S45 as the recommended charging time.

Subsequently, in S46, the ECU 150 sets the time obtained by subtracting the recommended charging time (S45) from the recommended charging end time (S43) as the recommended charging start time for the target day of the week stored in the storage device 152 (update of the recommended condition). For the non-target day of the week (the day of the week when the usage of the power storage device 110 by the vehicle user is not patterned), ECU 150 registers the second charging start timing (immediate charging) as the recommended charging start timing in storage device 152.

In the processing flow shown in FIGS. 5 and 6, the recommended charging condition of the power storage device 110 is determined for the day of the week (target day of the week) identified in S13 of FIG. 3. In a day of the week in which the usage of power storage device 110 is patterned, there is a high possibility that the transition of the power storage amount in power storage device 110 in one day is similar to the transition of the power storage amount indicated by the data of power storage device 110 in the past regarding the day of the week. For this reason, with respect to the target day of the week, it is easy to accurately obtain a charging condition that achieves both suppression of deterioration of the power storage device 110 and convenience of the user based on data (for example, charging history information and use history information) of the power storage device 110 in the past. For example, in the case where the power storage device 110 is charged on the day when the user uses the power storage device, it is required to determine the charging condition of the power storage device 110 so that the power storage device 110 is charged with the necessary amount of electric power before the time when the user starts using the power storage device 110. In order to suppress deterioration of the power storage device 110, it is preferable that charging of the power storage device 110 be completed at a timing close to the time at which the user starts using the power storage device 110. In order to suppress deterioration of the power storage device 110, it is preferable not to excessively increase the power storage amount in the power storage device 110 by charging. The ECU 150 may determine recommended charging conditions for the target day of the week by machine learning using artificial intelligence (AI).

In the processing flow of FIG. 5, the ECU 150 determines the recommended end-of-charging power storage amount (target SOC) of the power storage device 110 for the day of the week (target day of the week) identified in S13 using the charging amount indicated by the charging history information. In the processing flow of FIG. 6, ECU 150 uses the charging time indicated by the charging history information and the vehicle activation time indicated by the use history information to determine the recommended charging start time (first charging start timing) of power storage device 110 for the day of the week (target day of the week) identified in S13. As a result, the recommended charging condition is accurately acquired. According to the above-described method, it is possible to collectively determine the recommended charging conditions for the target day of the week near the vehicle activation time.

Referring back to FIG. 3, when the recommended condition of the target day of the week is updated by the process of S14, the process proceeds to S15. When it is determined in S11 that it is not the update timing of the recommended condition (NO in S11), the process proceeds to S15. The ECU 150 determines whether the day of the week today corresponds to the target day of the week based on the usage information stored in the storage device 152. If the day of the week today is the target day of the week (YES in S15), the process proceeds to S16, and if the day of the week today is a non-target day of the week (NO in S15), the process proceeds to S18.

In S16, the ECU 150 determines whether or not the recommended condition and the set condition (see FIG. 1) stored in the storage device 152 match. When the recommended condition and the set condition match (YES in S16), the processing flow shown in FIG. 3 ends. On the other hand, when the recommended condition and the set condition do not match (NO in S16), ECU 150 notifies the vehicle user of the recommended condition corresponding to the day of the week today in S17. Specifically, the ECU 150 causes the user terminal to display a screen Sc1 shown in FIG. 3. The user terminal is, for example, at least one of the HMI 140 and the mobile terminal 200. The screen Sc1 includes display units M11 to M13 and an operation unit M1. The display unit M11 displays the day of the week today. The display unit M12 displays the recommended condition (for example, the recommended charging start time and the recommended target SOC) corresponding to the day of the week today among the recommended conditions stored in the storage device 152. The display unit M13 displays the set conditions (for example, the set charging start time and the set target SOC) corresponding to the day of the week today among the set conditions stored in the storage device 152. When the user operates the operation unit M1 (for example, a button), the recommended condition indicated by the display unit M12 is set in the ECU 150. As a result, the recommended condition and the set condition stored in the storage device 152 coincide with each other.

In S18, the ECU 150 determines whether or not the charging start timing set for the day of the week today is the second charging start timing (immediate charging). When the second charging start timing is set for the day of the week today (YES in S18), the processing flow shown in FIG. 3 ends. On the other hand, when the second charging start timing is not set for the day of the week today (NO in S18), ECU 150 notifies the vehicle user that the second charging start timing is recommended as the charging start timing for the day of the week today (non-target day of the week) in S19. Specifically, ECU 150 causes at least one of HMI 140 and mobile terminal 200 (user terminal) to display screen Sc2 shown in FIG. 3. The screen Sc2 includes display units M21 to M23 and an operation unit M2. The display unit M21 displays the day of the week today. The display unit M22 displays a message indicating that the second charging start timing (immediate charging) is recommended. Among the set conditions stored in the storage device 152, the display unit M23 displays the charging start timing set for the day of the week today (note that the display unit M23 displays “no setting” if not set). When the user operates the operation unit M2 (for example, a button), the second charging start timing (immediate charging) is set in the ECU 150.

The notification to the user (display of the screens Sc1 and Sc2) in S17 and S19 ends when a predetermined time elapses without the user changing the set conditions (without operation on the operation units M1 and M2), for example. The user who has received the notification can select whether or not to set the recommended charging condition in the ECU 150 by his/her own intention. The user who has received the notification may set the charging condition in vehicle 100 so that charging of power storage device 110 according to the recommended charging condition is automatically performed, or may not set it.

In the processing flow of FIG. 3, the ECU 150 notifies (S17) the user of the recommended condition (recommended charging condition) determined by the processing flow shown in FIGS. 5 and 6 for the day of the week (target day of the week) identified in S13. In order to perform charging of the power storage device 110 in a planned manner, it is preferable to determine charging conditions prior to charging of the power storage device 110. In S17, the ECU 150 notifies the user to prompt the user to set recommended charging conditions for the target day of the week. Such a notification facilitates charging of the power storage device 110 under a condition in which suppression of deterioration of the power storage device 110 and convenience of the user are compatible with each other.

In S19 of FIG. 3, the ECU 150 notifies the user that the second charging start timing (timing at which the vehicle 100 becomes the chargeable state) is recommended as the charging start timing for the non-target day of the week. For a day of the week (non-target day of the week) on which the usage of the power storage device 110 is not patterned, since the usage of the power storage device 110 is unknown, it is difficult to present the charging start time to the user so as to achieve both suppression of deterioration of the power storage device 110 and convenience of the user. Therefore, in the above method, the ECU 150 notifies the user that the immediate charging is recommended for the non-target day of the week. Since the vehicle user often places the vehicle 100 in a chargeable state at a timing when charging becomes necessary for the vehicle 100, there is a low possibility that the user receives a disadvantage due to immediate charging. On the other hand, if an inappropriate charging start time is set in ECU 150, power storage device 110 may not be charged with a sufficient amount of power when starting use of vehicle 100 (power storage device 110). According to the processing flow of FIG. 3, the user can decide whether to set the immediate charging (second charging start timing) or to set an arbitrary charging start time (first charging start timing) exceptionally after understanding that the immediate charging is recommended in principle by the notification.

The management method for the power storage device according to this embodiment includes the processes shown in FIGS. 2, 3, 5, and 6. The processing flow shown in FIG. 3 includes: counting, for each day of the week, the number of days satisfying at least a first requirement indicating that charging of the power storage device 110 was performed and a second requirement indicating that the time when use of the power storage device 110 was started is included in a predetermined time period (for example, the time period Z) (S12); identifying a day of the week on which the usage of the power storage device 110 by a user is patterned, by using the number of days counted for each day of the week (S13); determining a recommended charging condition for the power storage device 110 for the identified day of the week (S14); and notifying the user of the recommended charging condition for the specified day of the week (S17). According to such a method, it is possible to present, to a user, a charging condition that achieves both suppression of deterioration of the power storage device 110 and convenience of the user.

In the above embodiment, the processing flow shown in FIG. 3 is started at the IGOFF time (the use end time of the power storage device 110). However, the start trigger of the processing flow shown in FIG. 3 can be appropriately changed. For example, the processing flow illustrated in FIG. 3 may be started every day at a preset time. In addition, the processing flow illustrated in FIG. 3 may be started in response to a user operation (for example, an operation of a button installed on the handle). In S17 and S19 of FIG. 3, the ECU 150 may execute a push notification or a pop-up notification to the user terminal (for example, the mobile terminal 200). The notification to the user may be a notification by voice instead of the display of the screen.

In the above embodiment, the pattern requirement includes the EVSE requirement in addition to the first requirement and the second requirement. This facilitates determining the recommended condition with high accuracy. However, it is not limited thereto, and the pattern requirement may not include the EVSE requirement.

In the above embodiment, the IGON time is adopted as the parameter indicating the use start time of the power storage device 110. Without being limited as such, any parameter indicating the use start time of the power storage device 110 can be adopted. For example, in a mode in which the vehicle 100 has a V2X function (for example, an external power supply function such as a V2H (Vehicle to Home) function) and the vehicle 100 periodically supplies power of the power storage device 110 to the outside of the vehicle by the V2X function, the time at which power supply by the V2X function is started may be employed instead of the IGON time. The power storage device to be managed is not limited to a power storage device mounted on a vehicle, and may be a stationary power storage device.

The processing flows illustrated in FIG. 2, FIG. 3, FIG. 5, and FIG. 6 can be appropriately changed. For example, the order of processing may be changed or unnecessary steps may be omitted depending on the purpose. Further, the contents of 10 any of the processes may be changed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A vehicle comprising a power storage device and a controller, wherein the controller is configured to
count, for each day of week, the number of days satisfying at least a first requirement indicating that charging of the power storage device was performed, and a second requirement indicating that a time when use of the power storage device was started is included in a predetermined time period,
identify a day of week on which usage of the power storage device by a user is patterned, by using the number of days counted for each day of week,
determine a recommended charging condition for the power storage device for the identified day of week, and
notify the user of the recommended charging condition for the identified day of week.

2. The vehicle according to claim 1, wherein
a charging start timing for each day of week is set for the controller based on an input from the user,
the controller is configured to accept the charging start timing that includes a first charging start timing indicating a charging start time specified by the user, and a second charging start timing indicating a timing when the vehicle becomes a chargeable state,
the controller is configured to start charging of the power storage device in accordance with the set charging start timing, and
the controller is configured to notify the user that the second charging start timing is recommended as the charging start timing for a day of week on which usage of the power storage device by the user is not patterned.

3. The vehicle according to claim 2, further comprising an activation switch that activates a vehicle system, wherein
the controller is configured to record first information about a charging history of the power storage device and second information about a use history of the power storage device,
the first information indicates a charging amount that is an amount of electric power with which the power storage device was charged, and a charging time that is a time from start to end of charging of the power storage device,
the second information indicates, as a time when use of the power storage device was started, a vehicle activation time when the activation switch was turned on for first time within a day,
an end-of-charging power storage amount for each day of week is further set for the controller based on an input from the user,
the controller is configured to end charging of the power storage device when a power storage amount of the power storage device reaches the set end-of-charging power storage amount,
the controller is configured to determine the end-of-charging power storage amount recommended to the power storage device for the identified day of week, by using the charging amount indicated by the first information, and
the controller is configured to determine the first charging start timing recommended to the power storage device for the identified day of week, by using the charging time indicated by the first information and the vehicle activation time indicated by the second information.

4. The vehicle according to claim 1, wherein
the controller is configured to
count, for each day of week, the number of target days within a target period that satisfy a pattern requirement including the first requirement and the second requirement,
calculate a patterning ratio for each day of week, by dividing the number of counted target days by a total number of days of week within the target period, and
identify, as a day of week on which usage of the power storage device by the user is patterned, a day of week for which the patterning ratio is more than or equal to a predetermined value, among Monday, Tuesday, Wednesday, Thursday, Friday, Saturday, and Sunday.

5. A management method for a power storage device, the management method comprising:
counting, for each day of week, the number of days satisfying at least a first requirement indicating that charging of the power storage device was performed, and a second requirement indicating that a time when use of the power storage device was started is included in a predetermined time period;
identifying a day of week on which usage of the power storage device by a user is patterned, by using the number of days counted for each day of week;
determining a recommended charging condition for the power storage device for the identified day of week; and
notifying the user of the recommended charging condition for the identified day of week.
